(19) United States
(12) Patent Application Publication
(10) Pub. No.: US 2016/0219126 A1
(43) Pub. Date: Jul. 28, 2016

(54) VIRTUAL DESKTOP PROVIDING METHOD AND VIRTUAL DESKTOP PROVIDING SERVER THEREOF

(71) Applicant: Electronics and Telecommunications Research Institute, Daejeon (KR)

(72) Inventors: Byeong Thaek OH, Daejeon (KR); Dae Won KIM, Daejeon (KR); Sun Wook KIM, Gyeonggi-do (KR); Seong Woon KIM, Chungcheongnam-do (KR); Jong Bae MOON, Daejeon (KR); Soo Cheol OH, Daejeon (KR); Jung Hyun CHO, Daejeon (KR); Hag Young KIM, Daejeon (KR)

(21) Appl. No.: 14/974,683

(22) Filed: Dec. 18, 2015

(30) Foreign Application Priority Data
Jan. 26, 2015 (KR) 10-2015-0012338

(51) Int. Cl. H04L 29/06; G06F 3/14; G06F 3/0481

(52) U.S. Cl. CPC H04L 67/42; G06F 3/0481; G06F 3/14

(57) ABSTRACT

Provided herein is a platform application service of a virtual desktop using virtualization technology, and more particularly, a virtual desktop providing method and virtual desktop providing server that support a lightweight protocol technology so that a virtual desktop service may be used smoothly even where a network environment is poor when providing a virtual desktop service, the virtual desktop providing method including collecting state information of a client terminal being received from the client terminal and state information of the virtual desktop providing server; determining an environment factor for a virtual desktop of the client terminal based on the state information of the client terminal and the state information of the virtual desktop providing server; and applying the environment factor and controlling the virtual desktop being serviced to the client terminal.

### CROSS-REFERENCE TO RELATED APPLICATION

The present application claims priority to Korean patent application number 10-2015-0012338, filed on Jan. 26, 2015, the entire disclosure of which is incorporated herein in its entirety by reference.

### BACKGROUND

1. Field of Invention

Various embodiments of the present invention relate to a platform application service of a virtual desktop using virtualization technology, and more particularly, to a virtual desktop providing method and a virtual desktop providing server that support lightweight protocol technology such that a virtual desktop service may be used smoothly even where a network environment is poor when providing the virtual desktop service.

2. Description of Related Art

Virtual Desktop (VD) technology is a technology wherein a desktop is virtualized using virtualization technology and is serviced in a host server so that a user may use the virtualized desktop environment using the Internet or a LAN. To use the virtual desktop, the user may access the virtual desktop using a traditional PC or thin client.

In general, an OS that a user uses as a virtual desktop is executed in a virtual desktop providing server, and user information and data are stored in a server instead of being directly stored in the user's terminal.

In a case where a client terminal accesses a virtual desktop using a virtual desktop client program, a network load between a server (may be referred to as a central server, or providing server and the like) that provides a virtual desktop service and the client terminal, and a CPU load of the server that provides the virtual desktop service may differ depending on the type of operation being driven on the virtual desktop. FIG. 1 illustrates a graph of network loads between a desktop providing server and a client terminal of each application program, that is type of operation, and a CPU load of the virtual desktop providing server.

Referring to FIG. 1, in a case where the client terminal is driving an operation using a general office application program on the virtual desktop, there is little load in the network and the server CPU. On the other hand, in a case where the client terminal is driving an operation such as web surfing or video replaying on the virtual desktop, the load of the network and server CPU becomes very big. That is, in a case of an operation that requires a lot of updates, the load of the network and server CPU increases.

In a case where the client terminal requests the virtual desktop for an operation that requires the load of the network and server to increase, there occurs a problem that the client terminal cannot use the virtual desktop service smoothly.

### SUMMARY

Various embodiments of the present invention are directed to resolve the aforementioned problem of the conventional technology, that is, to provide a lightweight protocol technology that enables using a virtual desktop service smoothly even in a poor network environment.

Furthermore, various embodiments of the present invention are directed to a virtual desktop providing method and virtual desktop providing server wherein a virtual desktop service providing server collects information on the network traffic, device specifications and computing resources of the client terminal from the client terminal in real time, determines an environment factor of the virtual desktop optimized to the client terminal based on the collected information, and provides the virtual desktop service optimized to the environment of the client terminal.

One embodiment of the present invention provides a virtual desktop providing method of a virtual desktop (VD) providing server, the method including collecting state information of a client terminal being received from the client terminal and state information of the virtual desktop providing server; determining an environment factor for a virtual desktop of the client terminal based on the state information of the client terminal and the state information of the virtual desktop providing server; and applying the environment factor and controlling the virtual desktop being serviced to the client terminal.

Another embodiment of the present invention provides a virtual desktop (VD) providing server including a communicator configured to receive state information of a client terminal from the client terminal; and a controller configured to collect state information of the virtual desktop providing server, determine an environment factor for a virtual desktop of the client terminal based on state information of the client terminal and state information of the virtual desktop providing server, and apply the environment factor to control the virtual desktop being serviced to the client terminal.

Another embodiment of the present invention provides a virtual desktop control method of a client terminal being provided with a virtual desktop service from a virtual desktop providing server, the method including collecting state information of the client terminal using a monitoring agent of the client terminal; and transmitting the state information of the client terminal to the virtual desktop providing server, wherein the state information of the client terminal is used for the virtual desktop to determine an environment factor for the virtual desktop of the client terminal.

Furthermore, the virtual desktop control method of a client terminal being provided with a virtual desktop service from a virtual desktop providing server involves providing an adaptive virtual desktop service of a quality suitable to use environment of the subject client terminal. The virtual desktop control method according to the present disclosure may adaptively change at least one of a screen transmission compression ratio, screen resolution, image compression ratio, audio compression ratio, image compression ratio, audio codec type, and image codec type, that are environment factors of the virtual desktop of the subject client terminal based on the state information of the client terminal received from the client terminal and the state information of the virtual desktop providing server.

Furthermore, the virtual desktop control method according to the present disclosure may involve dividing a screen transmission area differentially according to the network environment state and then an optimized screen transmission method being selected and serviced.

The virtual desktop providing method and virtual desktop providing server according to the present disclosure relates to a lightweight protocol technology that supports a virtual desktop service smoothly even where the network environment is poor, and in order to provide a virtual desktop service optimized to the access environment of the client terminal, a lightweight protocol may be provided to which an image compression engine configured to reduce a network bandwidth when transmitting a control engine and screen.

The virtual desktop providing method and virtual desktop providing server according to the present disclosure may collect and analyze a network traffic of the client terminal, device specifications and computing resources to provide an optimized service, and enable a user to be provided with the optimized virtual desktop service adaptively according to his/her network situation or changes in the computing resources.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a graph illustrating network loads between a virtual desktop providing server and client terminal per application program and a CPU load of a virtual desktop providing server;

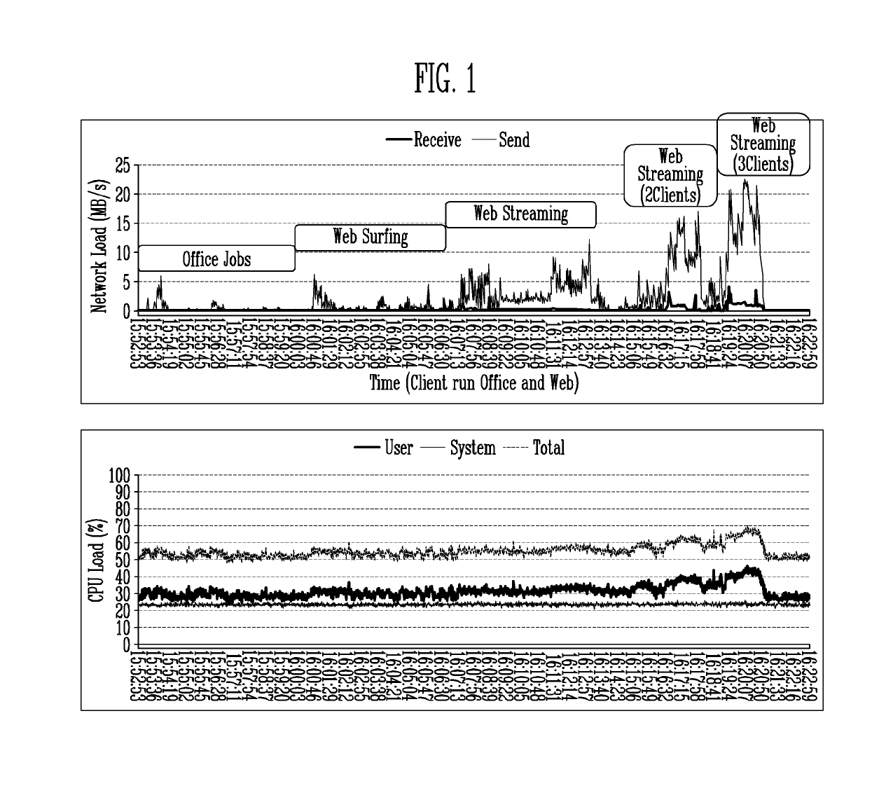

FIG. 2 is a view for explaining a virtual desktop service environment;

FIG. 3 is a block diagram illustrating a logical structure of a client terminal according to the present disclosure;

FIG. 4 is a block diagram illustrating a physical structure of a virtual desktop providing server according to the present disclosure;

FIG. 5 is a block diagram illustrating a logical structure of a virtual desktop providing server according to the present disclosure; and

FIG. 6 is a flowchart illustrating a method for providing a virtual desktop according to the present disclosure.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected/accessed’ represents that one component is directly connected or accessed to another component or indirectly connected or accessed through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

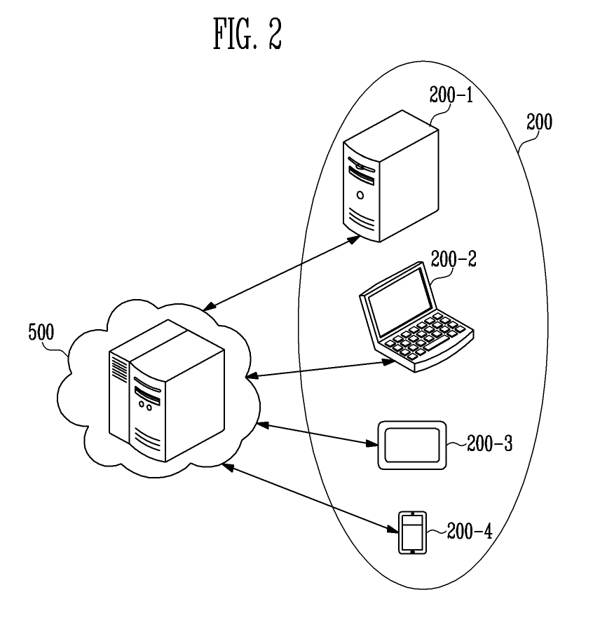

FIG. 2 is a view for explaining a virtual desktop service environment.

With reference to FIG. 2, in the virtual desktop service environment, each user terminal 200-1, 200-2, 200-3, 200-4 is connected to a desktop providing server 500 through a network such as WAN or LAN. In an embodiment, the user may connect his/her PC, notebook computer, tablet, and smart phone to the virtual desktop providing server 500 and use a virtual desktop for each terminal. Herein, each terminal operates as a client terminal that uses the virtual desktop.

A virtual platform pool tightly-couples virtual hardware resources of a virtualization server and a software image (user profile, application, operating system) to generate a virtual platform, and provides the generated platform to the user through a virtual platform transmission protocol. A multiple application driving function provided in the virtual platform provides an environment for driving each operating system based application program in the virtual platform. When providing a virtual desktop service, the virtual protocol receives an input through a keyboard, video, mouse and the like from a control apparatus and remote computing apparatus through the network, transmits an output to the remote computing apparatus, and defines a collection of a protocol message for accessing. Herein, the control apparatus may reside in both the client terminal and the virtual desktop providing server.

Virtual desktop service protocols may be divided into numerous communication channels according to a communication session order and type of communication channels (herein, all channels may be the remote computing apparatus). Each communication channel has a capability of controlling execution of a message and a capability of adding and removing a communication channel during an execution time in response to each communication channel. The communication channel may be defined in the following protocol formats:

Main channel that serves the role of main protocol session connection

Display channel for receiving updating of a remote display

Input channel for sending a mouse and keyboard event

Cursor channel for receiving a pointer shape and position

Replay channel for receiving an audio stream

Record channel for sending an audio capture

Hereinafter, a client terminal and virtual desktop providing server that operate in a virtual desktop service environment illustrated in FIG. 2 will be explained in detail.

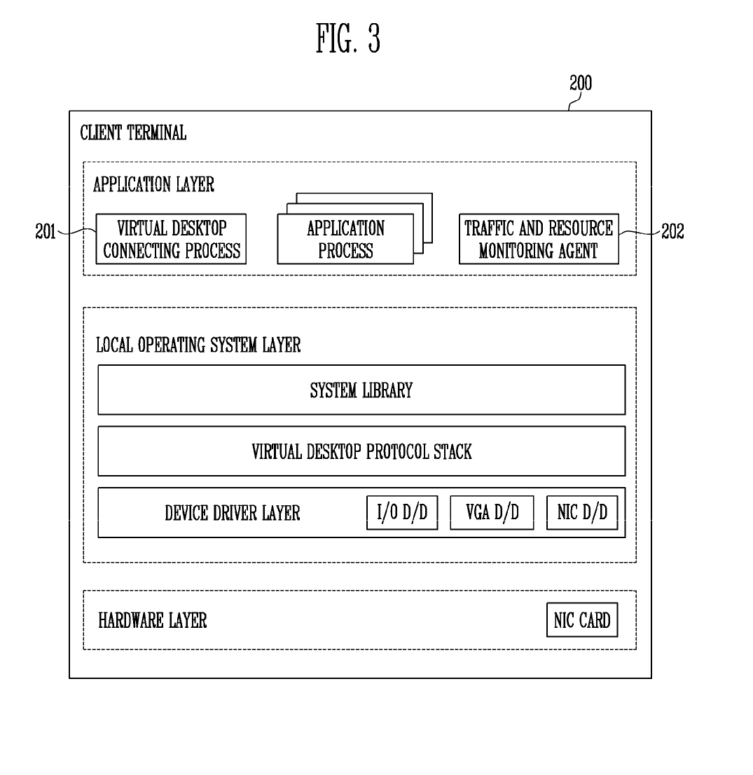

FIG. 3 is a block diagram illustrating a logical structure of a client terminal according to an embodiment of the present disclosure.

Referring to FIG. 3, the client terminal 200 according to the present disclosure drives a virtual desktop connecting process 201 and connects to a virtual operating system of the virtual desktop providing server, and receives a virtual desktop service from the virtual desktop providing server.

The client terminal 200 according to the present disclosure monitors a network traffic, device specification and state of computing resources of the client terminal 200 through a traffic and resource monitoring agent 202. The client terminal 200 may transmit the collected monitoring information to the virtual desktop providing server.

According to various embodiments of the present disclosure, the virtual desktop providing server may receive the information collected through the traffic and resource monitoring agent 202, and controls service quality of the virtual desktop based on the received information.

Other logical components of the client terminal 200 illustrated in FIG. 3 are the same as in the conventional technology, and thus detailed explanation is omitted.

Hereinafter, the configuration of the virtual desktop providing server will be explained in detail.

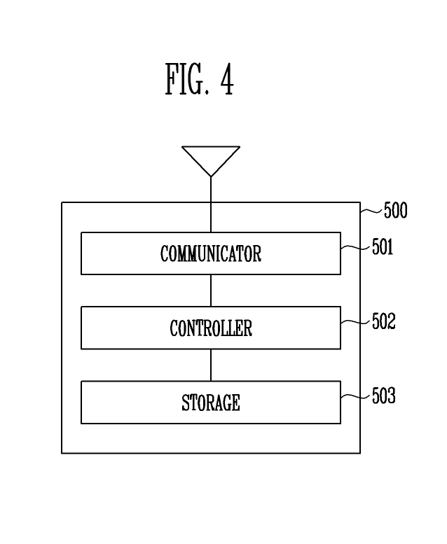

FIG. 4 is a block diagram illustrating a physical structure of the virtual desktop providing server according to the present disclosure.

Referring to FIG. 4, the virtual desktop providing server 500 includes a communicator 501, controller 502, and storage 503.

The communicator 501 performs data communication with outside. According to an embodiment of the present disclosure, the communicator 501 may perform data communication with a client terminal or virtual desktop management server. The communicator 501 may receive at least one of the information on the network traffic of the client terminal, device specifications and computing resources from the client terminal.

The controller 502 performs overall control of the virtual desktop providing server 500. For example, the controller 502 controls a service quality of the virtual desktop of the subject terminal based on at least one of the information on the network traffic of the client terminal, device specifications, and computing resources received through the communicator 501.

More specifically, the controller 502 monitors the network traffic, device specifications and computing resources of the virtual desktop providing server 500, and collects information on the network traffic, device specifications and computer resources. The controller 502 may collect such information through the virtual desktop providing server 500 and a monitoring agent provided in the operating system (OS).

The controller 502 determines an environment factor regarding the virtual desktop of the subject client terminal based on the state information of the client terminal received from the client terminal and the state information of the virtual desktop providing server 500. The environment factor may include at least one of a screen transmission compression ratio, screen resolution, image compression ratio, audio compression ratio, image compression ratio, audio codec type, and image codec typ.

The controller 502 applies the determined environment factor and controls the virtual desktop of the subject client terminal. The controller 502 may apply the determined environment factor and provide the virtual desktop of the quality suitable to the use environment of the subject client terminal.

The storage 503 may store a program, information and data necessary for operating the virtual desktop providing server 500. According to an embodiment of the present disclosure, the storage 503 may store state information on the network traffic, device specifications and computing resources of the client terminal. Furthermore, the storage 503 may store an environment factor (for example, screen transmission compression ratio, screen resolution, image compression ratio, audio compression ratio, image compression ratio, audio codec type, image codec type and the like) of the virtual desktop regarding at least one client terminal determined by the controller 502.

Hereinafter, an operation of the virtual desktop providing server 500 will be explained according to a logical structure.

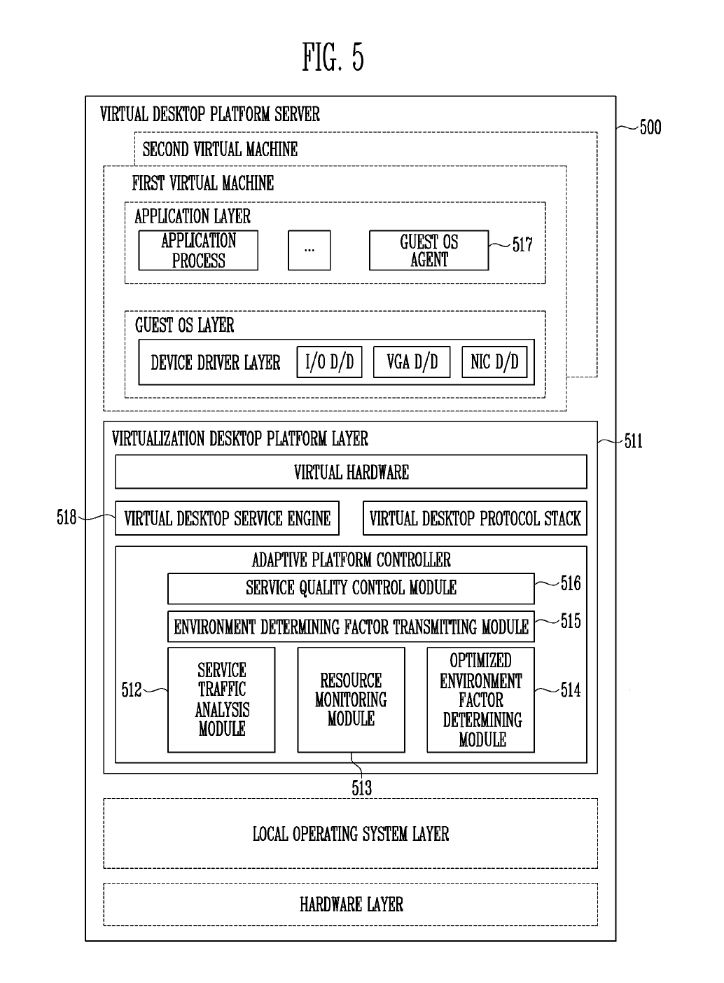

FIG. 5 is a block diagram illustrating the logical structure of the virtual desktop providing server according to the present disclosure. FIG. 5 illustrates major functions of the virtual desktop providing server in a case where the client terminal of the virtual desktop accesses the virtual desktop providing server through the network and uses the virtual desktop service. In various embodiments, the virtual desktop providing server may be called a virtual desktop platform providing server or virtual desktop central server and the like.

Referring to FIG. 5, the virtual desktop providing server 500 provides a dynamic lightweight protocol based adaptive type virtual platform service in order to provide a smooth virtual desktop service even in a client terminal of a poor network situation or computing situation. For this purpose, to the virtual desktop providing server 500, a lightweight protocol that utilizes a traffic analysis module configured to monitor and analyze the network of the client terminal, device specifications and computing resources state, network of the virtual desktop providing server 500, device specifications and computing resources state and an interface of the traffic analysis module. In order to provide a service optimized to the client terminal, the light weight protocol takes charge of monitoring the performance of the client terminal and network state. The virtual desktop providing server 500 has the environment factor of the virtual desktop optimized to the client terminal determined through the light weight protocol. In a case where a light weight protocol optimized system is being provided with stability, the virtual desktop providing server 500 may provide the client terminal with an adaptive type virtual platform service.

Referring to FIG. 5, the virtual desktop providing server 500 is provided with a virtual desktop platform layer 511.

In an embodiment of the present disclosure, the virtual desktop platform layer 511 includes a service traffic analysis module 512, and resource monitoring module 513. The service traffic analysis module 512 monitors the network traffic and collects information through the client terminal, virtual desktop providing server 500, and a guest operating system (Guest OS) 517 of the virtual desktop. The resource monitoring module 513 monitors the computing resources and collects information through the client terminal, virtual desktop providing server 500 and a guest operating system 517 monitoring agent of the virtual desktop.

An optimized environment factor determining module 514 is a module for determining an environment factor of the platform to providing the optimized service in the virtual platform, and the optimized environment factor determining module 514 analyzes the state information collected through the service traffic analysis module 512 and resource monitoring module 513, and determines the environment factor of the virtual desktop to be provided per client terminal. An optimized environment factor corresponding to the state information of the client terminal and the virtual desktop providing server may be determined according to a mapping table or predetermined rule, and there is no limitation to the determination method or condition. However, in a case where there is much network traffic or where there are insufficient computer resources, the resolution of the screen would be determined to be low. In order to determine the optimized environment factor, the optimized environment factor determining module 514 may analyze traffic and collect and manage resource analysis data according to various virtual platform service formats.

The environment factor transmission module 515 transmits the environment factor determined by the optimized environment factor determining module 514 to the service quality control module 516, and the service quality control module 516 actually applies the environment factor to the virtual desktop, thereby controlling the service quality of the virtual desktop. According to the aforementioned embodiment of the present disclosure, the environment factor is changed dynamically according to the information collected through analysis of the specifications of the client terminal, computing resources and network traffic.

The virtual desktop service engine 518 controls an adaptive virtual platform service based on the transmitted environment factors. The virtual desktop service engine 518 dynamically changes the video compression ratio and screen resolution and the like of the application program driving in the guest operating system 517 according to the control of the service quality control module 516, and provides an optimized service adaptively according to the network environment of the client terminal or computing resources.

Other logical components of the virtual desktop providing server 500 illustrated in FIG. 5 are the same as in the conventional technology, and thus detailed explanation omitted.

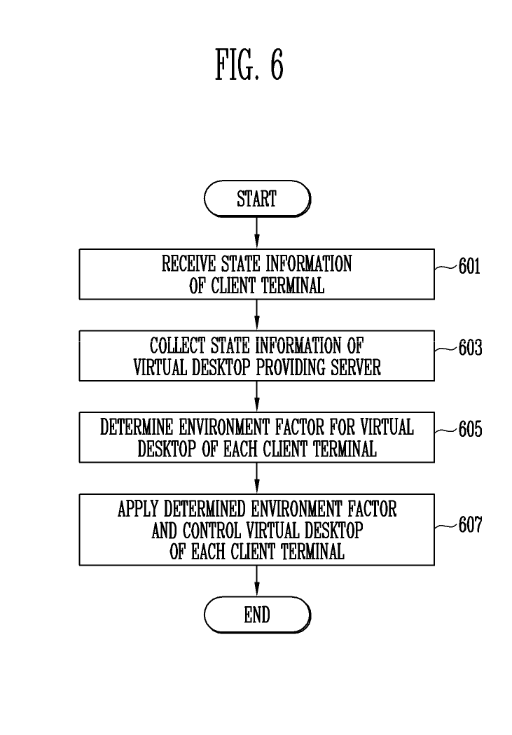

FIG. 6 is a flowchart illustrating a virtual desktop providing method according to the present disclosure.

Referring to FIG. 6, the virtual desktop providing server receives state information of the client terminal from the client terminal (601). The state information of the client terminal is information collected through the monitoring agent provided in the client terminal, and the state information may include at least one of information on the network traffic of the client terminal, and information on the device specifications and computing resources.

The virtual desktop providing server monitors the state of the virtual desktop providing server and collects state information of the virtual desktop providing server (603). The state information of the virtual desktop providing server may be collected through the virtual desktop providing server and the monitoring agent provided in the operating system (OS) of the virtual desktop, and may include at least one of the information on the network traffic of the virtual desktop providing server and the information on the device specifications and computing resources.

The virtual desktop providing server determines an environment factor for the virtual desktop of the client terminal based on the state information of the client terminal and the state information of the virtual desktop providing server (605). The virtual desktop providing server may analyze the collected information and determine an optimized environment factor for the virtual desktop that each client terminal uses. The environment factor may include at least one of the screen transmission compression ratio, screen resolution, image compression ratio, audio compression ratio, image compression ratio, audio codec type, and image codec type.

The virtual desktop providing server applies the determined environment factor and controls the virtual desktop of the client terminal (607).

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A virtual desktop providing method of a virtual desktop (VD) providing server, the method comprising:
collecting state information of a client terminal being received from the client terminal and state information of the virtual desktop providing server;
determining an environment factor for a virtual desktop of the client terminal based on the state information of the client terminal and the state information of the virtual desktop providing server; and
controlling the virtual desktop being serviced to the client terminal by applying the environment factor.

2. The method according to claim 1,
wherein the state information of the client terminal is collected through a monitoring agent provided in the client terminal.

3. The method according to claim 1,
wherein the state information of the client terminal comprises at least one of information on a network traffic of the client terminal, device specifications and information on computing resources.

4. The method according to claim 1,
wherein the state information of the virtual desktop providing server is collected through the resource monitoring module provided in the virtual desktop providing server and a monitoring agent provided in an operating system (OS) of the virtual desktop.

5. The method according to claim 1,
wherein the environment factor comprises at least one of a screen transmission compression ratio, screen resolution, image compression ratio, audio compression ratio, image compression ratio, audio codec type, and image codec type.

6. The method according to claim 1,
wherein as a control method according to performance of the client terminal or computing resources or network state, a screen transmission area is divided and an area having movement in a screen adaptively is transmitted according to performance of the client terminal, computing resources or network environment state, and then an optimized screen transmission method is selected and serviced.

7. A virtual desktop (VD) providing server comprising:
a communicator configured to receive state information of a client terminal from the client terminal; and
a controller configured to collect state information of the virtual desktop providing server, determine an environment factor for a virtual desktop of the client terminal based on state information of the client terminal and state information of the virtual desktop providing server, and apply the environment factor to control the virtual desktop being serviced to the client terminal.

8. The virtual desktop (VD) providing server according to claim 7,
wherein the state information of the client terminal is collected through a monitoring agent provided in the client terminal.

9. The virtual desktop (VD) providing server according to claim 7,
wherein the state information of the client terminal comprises at least one of information on a network traffic of the client terminal, device specifications and information on computing resources.

10. The virtual desktop (VD) providing server according to claim 7,
wherein the state information of the virtual desktop providing server is collected through the resource monitoring module provided in the virtual desktop providing server and a monitoring agent provided in an operating system (OS) of the virtual desktop.

11. The virtual desktop (VD) providing server according to claim 7,
wherein the environment factor comprises at least one of a screen transmission compression ratio, screen resolution, image compression ratio, audio compression ratio, image compression ratio, audio codec type, and image codec type.

12. A virtual desktop control method of a client terminal being provided with a virtual desktop service from a virtual desktop providing server, the method comprising:
collecting state information of the client terminal using a monitoring agent of the client terminal; and
transmitting the state information of the client terminal to the virtual desktop providing server,
wherein the state information of the client terminal is used for the virtual desktop to determine an environment factor for the virtual desktop of the client terminal.

13. The virtual desktop control method according to claim 12,
wherein the state information of the client terminal comprises at least one of information of a network traffic of the client terminal, device specifications and information on computing resources.
